(19) United States
(12) Patent Application Publication
(10) Pub. No.: US 2025/0355186 A1
(43) Pub. Date: Nov. 20, 2025

(54) WIDEBAND POLARIZATION SPLITTING GRATING COUPLER

(71) Applicant: Nvidia Corporation, Santa Clara, CA (US)

(72) Inventors: Peng SUN, Palo Alto, CA (US); Liron GANTZ, Haifa (IL)

(21) Appl. No.: 18/664,863

(22) Filed: May 15, 2024

(51) Int. Cl. G02B 6/34

(52) U.S. Cl. CPC G02B 6/34

(57) ABSTRACT

A broad bandwidth polarization splitting grating coupler is provided. The grating coupler includes a substrate (or at least a portion thereof) and a plurality of features formed on the substrate in a two-dimensional arrangement. The two-dimensional arrangement is defined by a regular two-dimensional lattice defining a plurality of lattice sites. Each position of the two-dimensional arrangement is displaced by a non-zero displacement from a corresponding lattice site of the plurality of lattice sites.

### BACKGROUND

Example embodiments generally relate to the field of grating couplers and optical systems including grating couplers. For example, an example embodiment provides a polarization splitting grating coupler.

Various optical systems, such as optical communication systems and/or the like, include various combinations of optical fibers and photonic integrated circuits (PICs) with light coupled between the optical fibers and PICs (other optical elements) using grating couplers. Polarization splitting grating couplers are configured to couple light of arbitrary polarization state from optical fibers to PICS, or vice versa. However, polarization splitting grating couplers tend to have wavebands of about 20 nm in the O-band. Coarse wavelength division multiplexing (CWDM) channels are generally spaced about 20 nm apart. Therefore, polarization splitting grating couplers are not appropriate for CWDM applications. Therefore, a need exists in the art for improved devices for performing optical coupling that are appropriate for CWDM applications and that are capable of efficient coupling of light having an arbitrary polarization state.

### BRIEF SUMMARY

Example embodiments provide wideband polarization grating couplers and systems including such grating couplers. In various embodiments, a grating coupler comprises a plurality of features. For example, the features may be polygonal pillars. In various embodiments, the feature may be pillars or holes (e.g., in a substrate or a layer formed on the substrate) of various shapes. The features are disposed in a two-dimensional arrangement. In various embodiments, the two-dimensional arrangement is defined by a regular two-dimensional lattice defining a plurality of lattice sites and each position of the two-dimensional arrangement is displaced by a non-zero displacement from a corresponding lattice site.

According to an example aspect of the present disclosure, a grating coupler is provided that includes a substrate and a plurality of features formed on the substrate in a two-dimensional arrangement. The two-dimensional arrangement is defined by a regular two-dimensional lattice defining a plurality of lattice sites and a plurality of two-dimensional displacements. Each lattice site is associated with a respective two-dimensional displacement of the plurality of two-dimensional displacements and the respective two-dimensional displacement indicates a location of a corresponding feature with respect to the lattice site.

According to another example aspect, a grating coupler is provided. In an example embodiment, the grating coupler includes a substrate and a plurality of features formed on the substrate in a two-dimensional arrangement. The two-dimensional arrangement is defined by a regular two-dimensional lattice defining a plurality of lattice sites and each position of the two-dimensional arrangement is displaced by a non-zero displacement from a corresponding lattice site of the plurality of lattice sites.

According to another example aspect, a system including a grating coupler of an example embodiment is provided. For example, the system may include a waveguide, an optical fiber, and a grating coupler of an example embodiment. The grating coupler is configured to couple light from the waveguide into the optical fiber or vice versa. In an example embodiment, the system uses wavelength division multiplexing (WDM).

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic top view of an example system including a grating coupler, according to an example embodiment;

FIG. 2 is a schematic side view of the example system shown in FIG. 1 and including the grating coupler, according to an example embodiment;

FIG. 3 is a schematic top view of a portion of an example grating coupler, according to an example embodiment;

FIGS. 4A and 4B illustrate example two-dimensional arrangements of respective grating couplers, according to example embodiments;

FIG. 5 illustrates example first and second components of two-dimensional displacements of an example two-dimensional arrangement of a grating coupler, according to an example embodiment;

FIG. 6 illustrates first components of two-dimensional displacements along a one-dimensional segment of a two-dimensional arrangement of the grating coupler illustrated in FIG. 5, according to an example embodiment; and

FIG. 7 illustrates the effect of the angle between the primary beam wavevector and the secondary beam wavevector on the bandwidth and loss of the grating coupler, according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

Various optical systems, such as optical communication systems and/or the like, include various combinations of optical fibers and photonic integrated circuits (PICs) with light coupled between the optical fibers and PICs (other optical elements) using grating couplers. Polarization splitting grating couplers (PSGCs) are configured to couple light having an arbitrary polarization state from optical fibers to PICS, or vice versa. However, PSGCs tend to have waveband bandwidths of about 20 nm in the O-band (1260-1360 nm), a common optical communications waveband. Coarse wavelength division multiplexing (CWDM) channels in the O-band are generally spaced about 20 nm apart. As such a PSCG can only efficiently support one CWDM channel. Therefore, PSGCs are not appropriate for CWDM applications. As such, there exist technical problems regarding performing optical coupling with a wide bandwidth (e.g., widen enough for use with CWDM applications) and that are capable of efficient coupling of light having an arbitrary polarization state.

Various embodiments provide technical solutions to these technical challenges. For example, various embodiments provide grating couplers that are PSGCs and that have a bandwidth of 30 nm or more in the O-band. Various embodiments may be configured for operation at wavelengths in the O-band, E-band, S-band, and/or C-band. For example, various embodiments provide grating couplers that include a plurality of features arranged in a two-dimensional (2D) arrangement or configuration. In various embodiments, the 2D arrangement and/or configuration is defined at least in part by a perturbed lattice. For example, in various embodiments, the 2D arrangement and/or configuration is defined by a regular and/or uniformly spaced 2D lattice defining a plurality of lattice sites and a plurality of 2D displacements. Each lattice site is associated with a respective two-dimensional displacement of the plurality of 2D displacements and the respective 2D displacement indicates a location of a corresponding feature with respect to the lattice site.

In various embodiments, the grating coupler is designed using an inverse design by adjoint method. In various embodiments, the grating coupler is designed to have a staggered pitch in a first direction and/or a second direction. For example, the grating coupler may be designed and/or configured to, responsive to an incident beam being incident thereon, provide two or more stagger-tuned beams that at least partially wrap an intended output vector. In an example embodiment, the grating coupler may be designed and/or configured to, responsive to an incident beam being incident thereon, provide up to four stagger-tuned beams that at least partially wrap an intended output vector.

By enabling the efficient coupling of light of arbitrary wavelength over a broad bandwidth, the grating couplers of various embodiments provide technical improvements to the fields of grating couplers and devices and systems that use grating couplers to couple between various optical components.

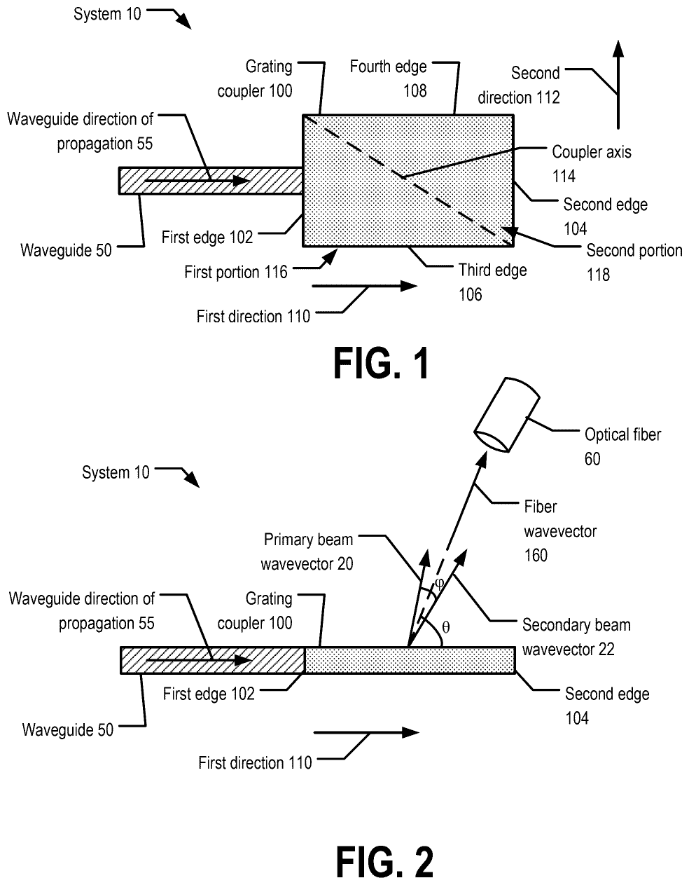

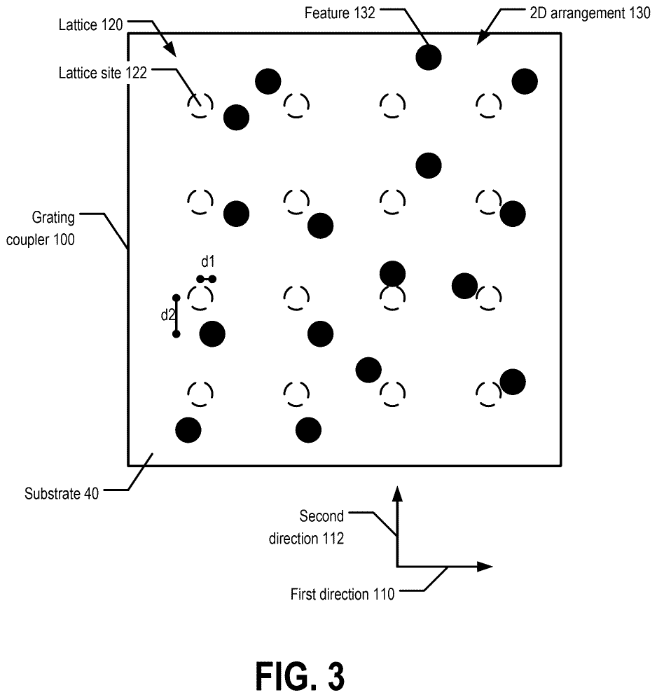

FIG. 1 provides a schematic top view illustration of a system 10 that includes a grating coupler 100 and FIG. 2 provides a schematic side view illustration of the system 10. A waveguide 50 is configured to provide light to the grating coupler 100. The grating coupler 100 couples the light out of the waveguide and into the optical fiber 60. As should be understood, various other systems may use the grating coupler 100 to coupler light from the optical fiber 60 into the waveguide 50, in accordance with various embodiments.

In various embodiments, the grating coupler 100 is formed on and/or comprises a least a portion of a substrate, such as a silicon substrate and/or the like. In various embodiments, the grating coupler 100 comprises a plurality of features that may be formed of and/or comprise silicon, silicon oxide, silicon nitride, and/or the like. In various embodiments, the grating coupler 100 comprises a material having a higher refractive index than that of the top and bottom cladding materials that clad the grating coupler 100. For example, in an example embodiment, the grating coupler 100 comprises silicon nitride and the material of the cladding that clads the grating coupler 100 comprises silicon dioxide or air. In another example, the grating coupler 100 comprises silicon and the material of the cladding that clads the grating coupler 100 comprises silicon nitride, silicon oxide, or a combination thereof.

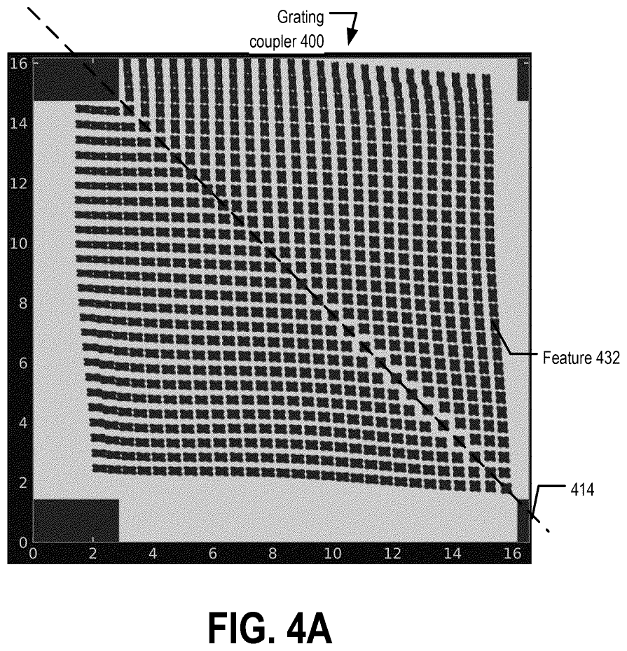

For example, an incident beam may propagate through the waveguide 50 in the waveguide direction 55. The incident beam is incident on a first edge 102 of the grating coupler 100. The grating coupler 100 includes a plurality of features 132 (see FIG. 3) that are arranged in a 2D arrangement or configuration 130. The waveguide direction 55 (and therefore the direction that the incident beam is traveling in when it meets the first edge 102) is within a plane defined by the 2D arrangement and/or configuration 130. The incident beam is incident on the first edge 102 and propagates across the grating coupler 100 in the first direction 110, causing the incident beam to interact with the plurality of features. As the incident beam interacts with the plurality of features 132, the optical power of the incident beam is scattered and/or guided such that a primary beam and a secondary beam are emitted in a direction that is out of the plane defined by the 2D arrangement and/or configuration 130.

The primary beam wavevector 20, which describes the direction of propagation of the primary beam, and the secondary beam wavevector 22, which describes the direction of propagation of the secondary beam, at least partially wrap a fiber wavevector 160 defined by the arrangement of the optical fiber 60 with respect to the grating coupler 100. For example, the primary beam wavevector 20 and the secondary beam wavevector 22 are on opposing sides of the fiber wavevector in three-dimensional space. In other words, fiber wavevector 160 is located between the primary beam wavevector 20 and the secondary beam wavevector 22. In various embodiments, the fiber wavevector 160 forms an angle θ with a plane parallel to the plane defined by the 2D arrangement of features. In various embodiments the angle θ is greater than zero degrees and less than 180 degrees. For example, in some embodiments, the angle θ is in a range of 50 to 120 degrees (e.g., 80 degrees).

In various embodiments, the primary beam and the secondary beam are stagger-tuned beams. For example, in various embodiments, the grating coupler 100 is configured to provide and/or generate two or more stagger-tuned beams responsive to an incident beam being incident thereon that was provided via the waveguide 50. For example, the plurality of 2D displacements is configured to cause the grating coupler 100 to provide two or more stagger-tuned beams with a designated and/or set angle φ therebetween. For example, the grating coupler 100 is designed and/or configured (e.g., via determining and/or defining of the plurality of 2D displacements) to provide stagger-tuned beams having and angle φ therebetween. In various embodiments, the angle φ is greater than zero degrees and no larger than 90 degrees. As the angle φ increases over the range from 0 to 90 degrees, the bandwidth of the grating coupler increases. However, the coupling loss of the grating coupler also increases. In various embodiments, the angle φ is in a range of 2 to 20 degrees. In some embodiments, the grating coupler 100 is designed and/or configured such that the angle q is in a range of 5 to 15 degrees (e.g., 10 degrees).

In an example embodiment, the grating coupler 100 defines a coupler axis 114. In various embodiments, the grating coupler 100 exhibits mirror symmetry across the couple axis 114. When an incident beam is incident on the first edge 102 of the grating coupler 100, a first portion 116 of the grating coupler (e.g., the portion of the grating coupler 100 between the first edge 102 and the coupler axis 114) generates the primary beam and the second portion 118 of the grating coupler (e.g., the portion of the grating coupler 100 between the coupler axis 114 and the second edge 104) generates the secondary beam. When an incident beam is incident on the fourth edge 108 of the grating coupler 100, the first portion 116 of the grating coupler (e.g., the portion of the grating coupler 100 between the first edge 102 and the coupler axis 114) generates the secondary beam and the second portion 118 of the grating coupler (e.g., the portion of the grating coupler 100 between the coupler axis 114 and the second edge 104) generates the primary beam.

FIG. 3 illustrates a small portion of an example grating coupler 100. The grating coupler 100 comprises a plurality of features 132 (shown as the solid, filled circles) that are arranged in a 2D arrangement and/or configuration 130. While FIG. 3 illustrates 16 features 132, in various embodiments, the grating coupler includes at least one hundred features. For example, in various embodiments, the grating coupler 100 includes 600-1200 features. The plurality of features 132 are formed on a substrate 40. For example, in various embodiments, each feature of the plurality of features 132 extends out from the substrate. For example, the features 132 may be polygonal pillars or other topological attribute. For example, in various embodiments, the features 132 are pillars that extend out from the substrate 40 and have a cross-sectional shape (in a plane parallel to the plane defined by the 2D arrangement and/or configuration 130) that is polygonal.

In various embodiments, the 2D arrangement and/or configuration 130 is defined at least in part by a regular 2D lattice 120 that defines a plurality of lattice sites 122, shown as dashed line circles. In various embodiments, the lattice 120 is a regular and/or uniform lattice where the spacing between pairs of adjacent lattice sites 122 is consistent and/or uniform across the lattice 120 (in both the first direction 110 and the second direction 112). In various embodiments, the lattice 120 is a rectangular lattice, an elliptical lattice, hexagonal lattice, and/or the like.

In various embodiments, the 2D arrangement and/or configuration 130 is defined at least in part by a plurality of 2D displacements that correspond to a respective lattice site 122 and corresponding feature 132. In various embodiments, a 2D displacement includes and/or consists of a first component d1 in a first direction 110 and a second component d2 in a second direction 112. For example, each position of the 2D arrangement and/or configuration 130 at which a respective feature of the plurality of features 132 is disposed is displaced by a non-zero displacement from a corresponding lattice site 122. In other words, each lattice site is associated with a respective two-dimensional displacement of the plurality of two-dimensional displacements and the respective two-dimensional displacement indicates a location of a corresponding feature 132 with respect to the lattice site 122. For example, the 2D displacement corresponding to a feature 132 indicates the relative position of the feature 132 with respect to the corresponding lattice site 122. For example, the plurality of 2D displacements characterizes the perturbation of the lattice 120 that provides the 2D arrangement and/or configuration 130.

In various embodiments, displacements are non-uniform across the grating coupler 100 in both the first direction and the second direction. For example, the first component d1 evolves and/or changes across the grating coupler 100 in the first direction 110 from a first edge 102 to a second edge 104 of the grating coupler. For example, the second component d2 evolves and/or changes across the grating coupler 100 in the second direction 112 from a third edge 106 to a fourth edge 108 of the grating coupler. In various embodiments, the evolution of the first component d1 and/or the second component d2 of the 2D displacements changes across a coupler axis 114 of the grating coupler 100. In various embodiments, the grating coupler 100 has dimensions (e.g., the first and second directions 110, 112) of 10 to 50 nm and the first components d1 and the second components d2 are in a range of −1 to +1 nm. In some embodiments, the first components d1 and components d2 are in a range of −0.5 to 0.5 nm. In various embodiments where the grating coupler 100 comprises silicon, each 7-14 nm of offset (e.g., the first component d1, second component d2, or the square root of the sum of the squares of the first component d1 and the second component d2) corresponds to approximately one degree of change in the beam angle of the primary and/or secondary beams.

In various embodiments, the 2D displacements are configured such that the features 132 are not in physical contact with one another. For example, the 2D displacements are configured such that the features 132 are each distinct features.

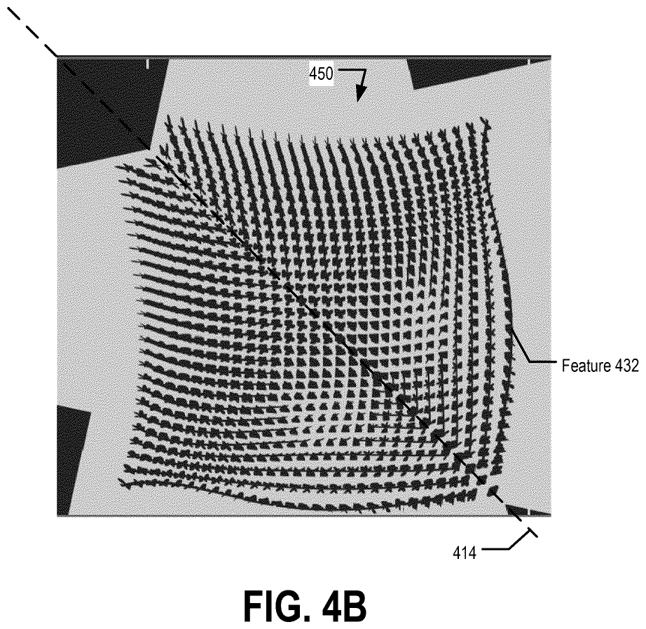

For example, FIG. 4A illustrates an example grating coupler 400 comprising a plurality of features 432. The grating coupler 400 is defined at least in part by a regular rectangular 2D lattice. FIG. 4B illustrates an example grating coupler 450 comprising a plurality of features. The grating coupler 450 is defined at least in part by a regular elliptical 2D lattice. As can be seen in FIGS. 4A and 4B, the grating couplers 400, 450 define respective coupler axes 414. In some embodiments, the coupler axis 414 is a symmetry axis of the grating coupler 400, 450. For example, in some embodiments, the grating coupler has mirror symmetry across the coupler axis 114. As should be understood, the 2D lattice is not physically present in the grating coupler but is merely used as a tool to define the positions of the 2D arrangement and/or configuration at which the features of the plurality of features are disposed.

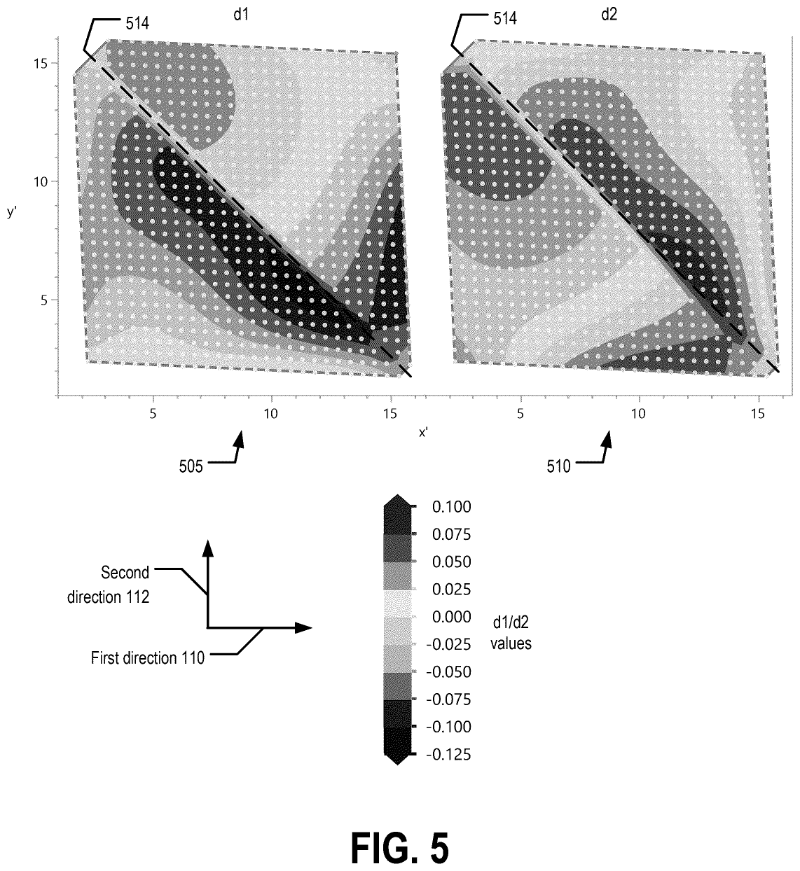

For example, FIG. 5 provides a first panel 505 that illustrates the first component d1 of the 2D displacement as a function of position in the first direction 110 (x′-direction) and the second direction 112 (y′-direction). FIG. 5 also provides a second panel 510 that illustrates the second component d2 of the 2D displacement as a function of position in the first direction 110 (x′-direction) and the second direction 112 (y′-direction). As shown in panels 505 and 510, the evolution of the first component d1 and the second component d2 changes across the coupler axis 514.

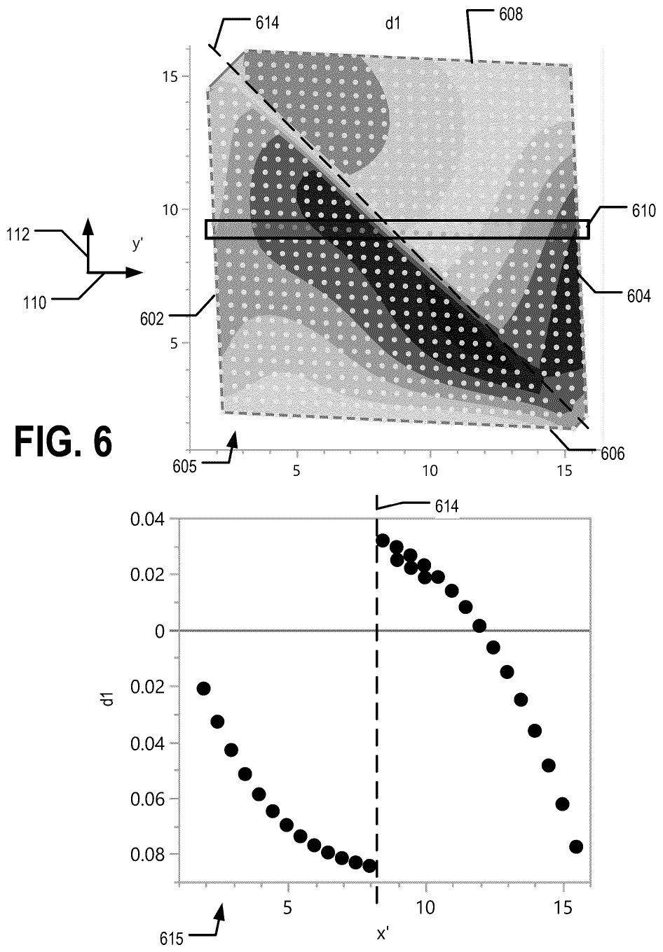

FIG. 6 provides a first panel 605 that illustrates the first component d1 of the 2D displacement as a function of position in the first direction 110 (x′-direction) and the second direction 112 (y′-direction) and indicates a particular strip 610 oriented in the first direction 110 of grating coupler 100. FIG. 6 provides a second panel 615 that illustrated the plots the value of the first components d1 of the plurality of 2D displacements as a function of position along the first direction 110 of the strip 610 from the first edge 602 of the grating coupler to the second edge 604 of the grating coupler. For example, a function describing the value of the first components d1 along the first direction 110 of the strip 610 includes a discontinuity at the coupler axis. For example, a function describing the value of the first components d1 along the first direction of the strip 610 may be a modified step function that smooths changes in the first component d1 from the center to respective edges.

As shown in panel 615, the first components of the 2D displacements evolve monotonically from the first edge 602 (and/or from within 2-3 nm of the first edge) to the coupler axis 614 along a line such as strip 610. Additionally, the first components d1 of the 2D displacements evolves monotonically from the coupler axis 614 to the second edge 604 (and/or to within 2-3 nm of the second edge) along a line such as strip 610. For example, in the illustrated embodiment, the first components d1 of the 2D displacement decrease (monotonically) from the first edge 602 (and/or within 2-3 nm of the first edge) to the coupler axis 614 and decreases (monotonically) from the coupler axis 614 to the second edge 604 (and/or to within 2-3 nm of the second edge). In some instances, due to the influence of edge effects one the design of the grating coupler, the evolution of the first components d1 may not be purely monotonic within 2-3 nm of the first edge 602 and/or the second edge 604.

In the illustrated embodiment, the evolution of the first components d1 of the 2D displacements across the coupler axis 614 in the first direction 110 is not monotonic with the evolution of the first components d1 between the first edge 602 and the coupler axis 614 and the coupler axis 614 and the second edge 604. For example, the first components d1 of the 2D displacements “jump” as the coupler axis 614 is crossed. For example, in the illustrated embodiment, the first components d1 of the 2D displacements increase across (in the first direction 110) the coupler axis 614. For example, the evolution of the first components d1 of the plurality of 2D displacements are discontinuous across the coupler axis 614.

As can be seen in panel 510, in various embodiments, the second components d2 of the plurality of 2D displacements evolve monotonically from the third edge 606 (and/or within 2-3 nm of the third edge) to the coupler axis 614 along a line or strip in the second direction 112. Additionally, the second components d2 of the 2D displacements evolve monotonically from the coupler axis 614 to the fourth edge 608 (and/or within 2-3 nm of the fourth edge) along the line or strip in the second direction 112. For example, in the illustrated embodiment, the second components of the 2D displacements decrease (monotonically) from the third edge 606 (and/or within 2-3 nm of the third edge) to the coupler axis 614 and decrease (monotonically) from the coupler axis 614 to the fourth edge 608 (and/or within 2-3 nm of the fourth edge). In some instances, due to the influence of edge effects one the design of the grating coupler, the evolution of the second components d2 may not be purely monotonic within 2-3 nm of the third edge 606 and/or the fourth edge 608.

In the illustrated embodiment, the evolution of the second components d2 of the 2D displacements across the coupler axis 614 in the second direction 112 is not monotonic with the evolution of the second components d2 between the third edge 606 and the coupler axis 614 and the coupler axis 614 and the fourth edge 608. For example, the second components d2 of the 2D displacements “jump” as the coupler axis 614 is crossed. For example, in the illustrated embodiment, the second components d2 of the 2D displacements increase across (in the second direction 112) the coupler axis 614. For example, the evolution of the second components d2 of the plurality of 2D displacements are discontinuous across the coupler axis 614. For example, a function describing the value of the second components d2 along the second direction 112 of a strip from the third edge 606 to the fourth edge 608 includes a discontinuity at the coupler axis 614. For example, a function describing the value of the second components d2 along a strip extending in the second direction may be a modified step function that smooths changes in the first component d1 from the center to respective edges.

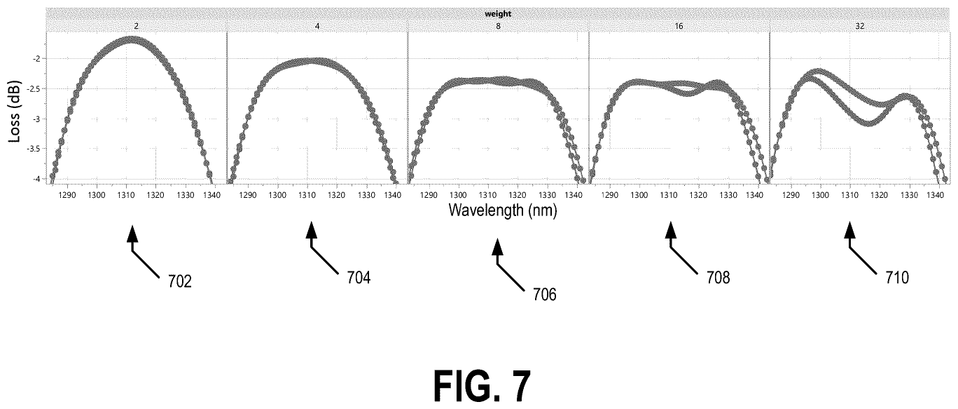

In various embodiments, the grating coupler has a bandwidth of 20 nm or more. In various embodiments, the loss across the bandwidth of the grating coupler is less than-4 dB. In various embodiments, the grating coupler has similar responses to p-polarized light and to s-polarized light. For example, FIG. 7 provides a series of panels 702-710 that illustrate the spectral response of example embodiments of grating couplers for both p-polarized light and s-polarized light for different angular spreading between the primary beam and the secondary beam (e.g., for different angles between the primary beam wavevector 20 and the secondary beam wavevector 22).

In particular, the angular distance between the primary beam wavevector 20 and the secondary beam wavevector 22 generated, emitted, and provided by the grating coupler increases from panel 702 through panel 710. The bandwidth of the grating coupler also increases from panel 702 through panel 710. For example, as the angular distance between the primary beam wavevector 20 and the secondary beam wavevector 22 generated, emitted, and provided by the grating coupler increases, the bandwidth of the grating coupler also tends to increase with a tradeoff of loss also increasing.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A grating coupler comprising:
a substrate; and
a plurality of features formed on the substrate in a two-dimensional arrangement, wherein the two-dimensional arrangement is defined by a regular two-dimensional lattice defining a plurality of lattice sites and a plurality of two-dimensional displacements, wherein each lattice site is associated with a respective two-dimensional displacement of the plurality of two-dimensional displacements, the respective two-dimensional displacement indicates a location of a corresponding feature with respect to the lattice site, and the respective two-dimensional displacement is non-zero in at least one direction.

2. The grating coupler of claim 1, wherein each two-dimensional displacement comprises a first component corresponding to a first direction and a second component corresponding to a second direction.

3. The grating coupler of claim 2, wherein along at least one line in the first direction across the two-dimensional arrangement from a first edge to a coupler axis, first components of the two-dimensional displacements evolve monotonically and along the at least one line in the first direction across the two-dimensional arrangement from the coupler axis to a second edge, the first components of the two-dimensional displacements evolve monotonically.

4. The grating coupler of claim 3, wherein an evolution of the first components across the coupler axis in the first direction is not monotonic with the evolution of the first components between the first edge and the coupler axis or with the evolution of the first components between the coupler axis and the second edge.

5. The grating coupler of claim 3, wherein either (a) the first components decrease along the first direction from a first edge to the coupler axis, increase across the coupler axis, and decrease from the coupler axis to the second edge or (b) the first components increase along the first direction from the first edge to the coupler axis, decrease across the coupler axis, and increase from the coupler axis to the second edge.

6. The grating coupler of claim 3, wherein the first direction is parallel to an incident beam propagation direction.

7. The grating coupler of claim 2, wherein along at least one line in the second direction across the two-dimensional arrangement from a third edge to a coupler axis, second components of the two-dimensional displacements evolve monotonically and along the at least one line in the second direction across the two-dimensional arrangement from the coupler axis to a fourth edge, the second components of the two-dimensional displacements evolve monotonically.

8. The grating coupler of claim 7, wherein an evolution of the second components across the coupler axis in the second direction is not monotonic with the evolution of the second components between the third edge and the coupler axis or with the evolution of the second components between the coupler axis and the fourth edge.

9. The grating coupler of claim 2, wherein the two-dimensional displacements are non-uniform in at least one of the first direction or the second direction.

10. The grating coupler of claim 1, wherein a feature of the plurality of features comprises a polygonal pillar that extends out from the substrate.

11. The grating coupler of claim 1, wherein the plurality of features comprises 600-1200 features.

12. The grating coupler of claim 1, wherein the grating coupler is configured to, responsive to an incident beam being incident thereon with a direction of propagation within a plane defined by the two-dimensional arrangement, cause a primary beam and a secondary beam to be emitted out of the plane defined by the two-dimensional arrangement.

13. The grating coupler of claim 1, wherein the grating coupler has a bandwidth that is 2-3 times broader than conventional grating couplers formed of same materials as the grating coupler and having 2D displacements of zero.

14. The grating coupler of claim 1, wherein the lattice is one of a rectangular lattice or an elliptical lattice.

15. The grating coupler of claim 1, wherein the grating coupler is a polarization splitting grating coupler.

16. The grating coupler of claim 1, wherein the plurality of two-dimensional displacements is determined using inverse design by adjoint method.

17. The grating coupler of claim 1, wherein the grating coupler has a coupler loss of less than −4 dB.

18. The grating coupler of claim 1, wherein the plurality of features are discrete features that are not in physical contact with one another.

19. A grating coupler comprising:
a substrate; and
a plurality of features formed on the substrate in a two-dimensional arrangement, wherein the two-dimensional arrangement is defined by a regular two-dimensional lattice defining a plurality of lattice sites and each position of the two-dimensional arrangement is displaced by a non-zero displacement from a corresponding lattice site of the plurality of lattice sites.

20. The grating coupler of claim 19, wherein the grating coupler is configured to, responsive to an incident beam being incident thereon from a direction within a plan defined by the two-dimensional arrangement, cause a plurality of stagger-tuned beams to be emitted out of the plane defined by the two-dimensional arrangement.
